(19) United States
(12) Patent Application Publication
(10) Pub. No.: US 2022/0003465 A1
(43) Pub. Date: Jan. 6, 2022

(54) INTERNAL HEAT EXCHANGER OF HEAT EXCHANGE SYSTEM

(71) Applicant: DENSO International America, Inc., Southfield, MI (US)

(72) Inventor: William BECKER, Oak Park, MI (US)

(21) Appl. No.: 16/919,184

(22) Filed: Jul. 2, 2020

(51) Int. Cl. F25B 39/02; F25B 13/00; F28D 7/00

(52) U.S. Cl. CPC F25B 39/02; F28D 7/0066; F25B 13/00

(57) ABSTRACT

A heat exchange system is provided with an improved internal heat exchanger (IHX). The system includes a loop configured to circulate refrigerant through a compressor, a condenser downstream of the compressor, an expansion valve downstream of the condenser, and an evaporator downstream of the expansion device and upstream of the compressor. The system also includes an internal heat exchanger (IHX) configured to transfer heat between (i) fluid passing from the condenser to the expansion device and (ii) fluid passing from the evaporator to the compressor. In embodiments, the IHX defines a first flow path configured to transfer the fluid passing from the condenser to the expansion device, and a second flow path configured to transfer the fluid passing from the evaporator to the compressor. The first flow path crosses the second flow path within the interior of the IHX.

### TECHNICAL FIELD

The present disclosure relates to an internal heat exchanger for use within a heat exchange system, such as an air conditioning or refrigeration system.

### BACKGROUND

A basic refrigeration or air conditioning system has a compressor, a condenser, an expansion device, and an evaporator. These components are generally connected in a loop via a fluid conduit or piping. At various stages along the loop, the fluid may change state (e.g., from gas to a liquid, and vice versa), and may undergo various pressure and temperature changes. Heat exchange can also take place with passing fluids within the loop.

### SUMMARY

In one embodiment, a heat exchange system includes a loop configured to circulate refrigerant through a compressor, a condenser downstream of the compressor, an expansion valve downstream of the condenser, and an evaporator downstream of the expansion device and upstream of the compressor. The system also includes an internal heat exchanger (IHX) configured to transfer heat between (i) fluid passing from the condenser to the expansion device and (ii) fluid passing from the evaporator to the compressor. The IHX is a unitary single device and defines a first flow path configured to transfer the fluid passing from the condenser to the expansion device, and a second flow path configured to transfer the fluid passing from the evaporator to the compressor, wherein the first flow path crosses the second flow path within the IHX.

In an embodiment, an internal heat exchanger (IHX) for a heat exchange system includes an interior surface extending about and along a longitudinal axis and defining a first flow path configured to transfer a refrigerant from an evaporator to a compressor; and a plurality of hollow tubes formed within the IHX, with the tubes extending across the longitudinal axis radially inward of the interior surface. The tubes define a portion of a second flow path configured to transfer the refrigerant from a condenser to an expansion device. The fluid in the first flow path flows past the tubes to exchange heat between the fluid in the first flow path and the fluid in the second flow path.

### BRIEF DESCRIPTION OF THE DRAWINGS

FIG. 1 is a schematic of a heat exchange system with an internal heat exchanger (IHX), according to one embodiment.

FIG. 2A is a perspective view of a portion of the IHX of FIG. 1, according to an embodiment.

FIG. 2B is a front view taken from region 2B of FIG. 2A.

FIG. 2C is a cross-sectional view taken along line 2C of FIG. 2B.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

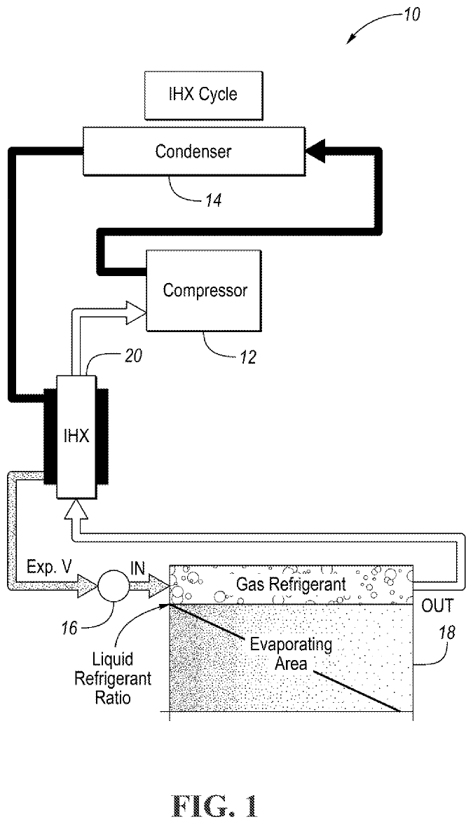

FIG. 1 illustrates a schematic of a heat exchange system 10, according to one embodiment. The system 10 includes a loop of fluid (e.g., refrigerant, coolant, etc.) that can exchange heat and change phase (e.g., gas to liquid, vice versa). Within the loop and system 10 is a compressor 12, which is configured to delivery hot high-pressure fluid gas to a condenser 14, where the gas is cooled and may be at least partially (or fully) converted to a liquid form. The fluid from the condenser 14 is expanded to a lower pressure through an expansion device or expansion valve 16, thereby undergoing a rapid drop in temperature. Once reduced in pressure and temperature at the expansion valve 16, the fluid is then sent to an evaporator 18. Within the evaporator 18, the fluid can be a mix of liquid and gas, and the fluid can be heated slightly. The gas fluid can exit the evaporator 18, whereupon the fluid is transferred toward the compressor 12, thus completing the loop.

In one embodiment, and for illustrative purposes only, the fluid may exit the compressor 12 at roughly 80 degrees Celsius (C), may exit the condenser at 60 degrees C., and may enter the heat exchange valve at 50 degrees C. (due to heat exchange by an internal heat exchanger, described in more detail below). The evaporating area within the evaporator may store the fluid at 0 degrees C., and the gas fluid leaving the evaporator may be between 0-2 degrees C.

In some heat exchange systems such as one described above, it may be beneficial to assure that liquid refrigerant does not enter the compressor. Therefore, it may be beneficial to have more improved heat exchange upstream of the compressor. An internal heat exchanger (IHX) 20 is therefore provided. The IHX helps regulate the refrigerant coming from the evaporator prior to entering the compressor, allowing heat transfer to take place with the fluid that is entering the expansion valve. This allows the fluid to remain cold (e.g., 0-2 degrees C.) as it leaves the evaporator, while the IHX can increase the temperature of the fluid (e.g., by 8-10 degrees C.) before the fluid enters the compressor 12. This also cools the fluid that is entering the evaporator, before the fluid reaches the expansion valve 18.

In general, high temperature fluid exiting the condenser 14 flows into the IHX 20 prior to flowing into the expansion valve 16. At the same time, low temperature, low pressure fluid flowing from the evaporator 18 enters the IHX 20 prior to flowing into the compressor 12. The high temperature liquid fluid from the condenser 14 interacts with the low temperature gaseous fluid from the evaporator 20 in a heat exchange relationship within the IHX 20. As a result, the liquid refrigerant flowing from the condenser 14 is cooled and can thereby absorb more heat as it flows through the evaporator 18. The gaseous refrigerant exiting the IHX 20 is heated, having absorbed heat from the high pressure, high temperature liquid fluid. As a result, any liquid fluid that may remain in the low pressure, low temperature fluid will be converted into a gas in the IHX 20. This reduces the risk of having liquid flow into the compressor 12.

Previous designs of internal heat exchangers include pipes that are designed based on manufacturing methods, sacrificing efficiency and adaptability to different vehicles. Previous internal heat exchangers typically include an inner pipe that is shaped and nested within an outer pipe. The inner pipe may have an outer surface with a corkscrew or twisted surface feature, and liquid refrigerant is channeled in the space between the surface feature on the outer surface of the inner pipe, and the inner surface of the outer pipe. Meanwhile, gas refrigerant travels through the inner pipe guided by the hollow, cylindrical inner surface of the inner pipe. During manufacturing, the outer pipe is brazed over the inner pipe, and then the connected pipes are twisted and bent to shape. This involves expensive manufacturing processes and imposes packaging restrictions.

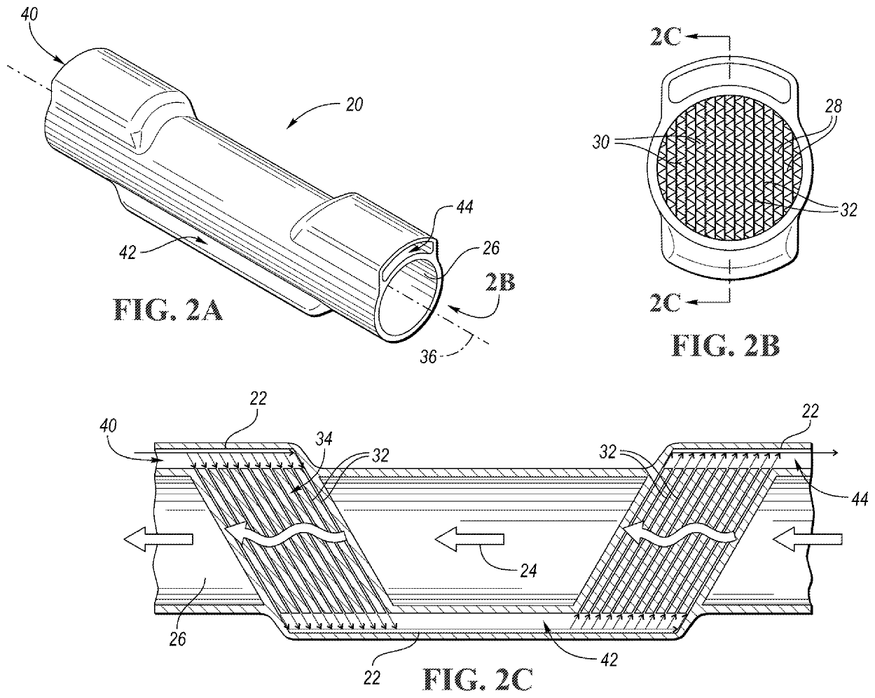

Referring to FIGS. 2A-C, the IHX 20 is formed as a unitary, single structure with customized cross-flow patterns formed therein to optimize heat transfer. The IHX 20 may be formed via three-dimensional (3D) printing, for example, which provides the benefit of being able to manufacture very minute and intricate internal fluid passages. By being formed as a unitary, single structure, the IHX 20 may not include multiple parts brazed or otherwise connected or assembled together to form the IHX 20; instead, the IHX can be a single piece through and through. The IHX 20 may include a combination of suction and liquid pipes that allow for heat exchange between crossing fluids. For example, in the illustrated embodiment, suction applied by the compressor 12 draws liquid fluid or refrigerant through a first flow path 22 of the IHX 20. Meanwhile, gas fluid or refrigerant is sent through a second flow path 24. Heat can be exchanged from the fluid in the first flow path 22 crossing the fluid in the second flow path 24 separated by solid material (e.g., metal) that defines the flow paths 22, 24.

In one embodiment, the second flow path 24 is defined by an interior surface 26 of the IHX 20. The interior surface 26 is generally cylindrical, and extend in an elongated fashion along the length of the IHX 20. The interior surface 26 guides the gas refrigerant from the evaporator 18 to the compressor 12. A plurality of fins 28 extend within the second flow path 24. The fins 28 can be made of a solid material, such as metal, and made as a unitary and integral extension of the interior surface 26 via, for example, 3D printing. The fins 28 zig-zag vertically downward as shown in the orientation of FIG. 2B. A plurality of gaps 30 exist in the spaces between the fins 28. The gas refrigerant can flow past the fins 28 through these gaps 30, thus allowing heat from the fins 28 to transfer to the gas refrigerant.

While the fins 28 are shown in a zig-zag pattern, other designs are contemplated, depending on the desired heat transfer characteristics. And furthermore, 3D printing can enable intricate structural formations of the fins 28. For example, in another embodiment, the fins 28 are provided in a honeycomb pattern. In other embodiments, the fins 28 are created in an X-shape, circular shape, or other shapes. As the gas refrigerant passes over the fins 28, the gas refrigerant is heated via heat transfer between the gaseous fluid passing over the solid fins.

In one embedment, the first flow path 22 is at least partially defined by a plurality of pipes or tubes 32 extending radially inside of the interior surface 26 of the IHX 20. In other words, the tubes 32 extend within the IHX 20 such that the gas refrigerant passes over the tubes 32. The tubs 32 are hollow and contain the liquid refrigerant passing from the condenser 14 to the expansion device 16. The interior of the tubs 32 therefore at least partially define the first flow path 22.

The fins 28 may extend between and connect adjacent tubes 32. Thus, in a region 34 of the IHX 20 where the tubes 32 pass the liquid refrigerant from one side of the IHX 20 (e.g., the top) to the other (e.g., the bottom), the fins 28 and tubes 32 create a matrix of solid material for the gas refrigerant to pass through; the gas refrigerant passes through the gaps 30 between the solid material that defines the fins 28 and tubes 32. Within the region 34, the gas refrigerant passes over the outer surfaces of the tubes 32, thus exchanging heat with the liquid refrigerant passing within the tubes 32.

In the illustrated embodiment, the tubes 32 extend at an angle oblique relative to a longitudinal axis 36 of the IHX 20. In other embodiments, the tubes 32 may extend transverse to the longitudinal axis 36 of the IHX 20. The longitudinal axis 36 may be the central axis of the IHX 20, with the interior surface 26 being centered about and extending along the longitudinal axis 36.

The IHX 20 may be provided with a plurality of outer headers or channels 40, 42, 44 located outboard of the inner surface 26 of the IHX 20. The channels 40, 42, 44 may provide a region of collecting of the liquid refrigerant before and after the refrigerant is separated into the individual tubes 32. In other words, the channels 40, 42, 44 may pool the liquid refrigerant, allowing the liquid refrigerant to mix and exchange heat amongst itself after traveling through the individual tubes 32, before traveling through another group of tubes 32. The IHX 20 may be provided with multiple channels 40 on alternating sides of the inner surface 26, alternating across the longitudinal axis 32. For example, a first channel 40 may pool the liquid refrigerant before entering tubes 32, and thereafter channel 42 collects or pools the liquid refrigerant on the opposite side of the longitudinal axis 36, whereupon the fluid travels back across the longitudinal axis via tubes 32 into channel 44. This allows the liquid refrigerant to weave and alternate within the interior surface 26 of the IHX 20. The liquid refrigerant may alternate in a sinusoidal pattern, passing from channel 40 to channel 40 via the tubes 32, as indicated by the arrows of the first flow path 22. The channels 40, 42, 44 may also be formed unitarily with the material of the IHX 20 via, for example, 3D printing.

The IHX described herein allows for use of a more efficient IHX without needing to conform to manufacturing restrictions. More efficient heat exchange can take place within the IHX due to the fins and cross-flow within the IHX. Having a more efficient IHX allows for a smaller evaporator, improving packaging space within the vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A heat exchange system, comprising:
a loop configured to circulate refrigerant through a compressor, a condenser downstream of the compressor, an expansion valve downstream of the condenser, and an evaporator downstream of the expansion device and upstream of the compressor; and
an internal heat exchanger (IHX) configured to transfer heat between (i) fluid passing from the condenser to the expansion device and (ii) fluid passing from the evaporator to the compressor;
wherein the IHX is a unitary single device, and wherein the IHX defines a first flow path configured to transfer the fluid passing from the condenser to the expansion device, and a second flow path configured to transfer the fluid passing from the evaporator to the compressor, wherein the first flow path crosses the second flow path within the IHX.

2. The heat exchange system of claim 1, wherein the IHX further includes a plurality of tubes formed as part of the unitary single device, wherein the tubes define a portion of the first flow path intersect a central longitudinal axis of the IHX.

3. The heat exchange system of claim 2, wherein the tubes extend oblique relative to the central longitudinal axis of the IHX.

4. The heat exchange system of claim 1, wherein the IHX further includes a plurality of fins, each connecting an adjacent pair of the tubes, and wherein a gap exists between the fins and tubes for guiding the fluid passing from the evaporator to the compressor.

5. The heat exchange system of claim 1, wherein the second flow path is defined by a generally cylindrical inner surface of the IHX.

6. The heat exchange system of claim 5, wherein the IHX further includes a plurality of channels outboard of the inner surface of the IHX, wherein the channels define at least a portion of the first flow path.

7. The heat exchange system of claim 6, wherein the channels alternate across opposite sides of the IHX relative to a central longitudinal axis of the IHX.

8. The heat exchange system of claim 6, wherein the IHX further includes a plurality of tubes that define a portion of the first flow path, and wherein the tubes deliver fluid from a first of the channels to a second of the channels.

9. An internal heat exchanger (IHX) for a heat exchange system, the IHX comprising:
an interior surface extending about and along a longitudinal axis and defining a first flow path configured to transfer a refrigerant from an evaporator to a compressor; and
a plurality of hollow tubes formed within the IHX, the tubes extending across the longitudinal axis radially inward of the interior surface, wherein the tubes define a portion of a second flow path configured to transfer the refrigerant from a condenser to an expansion device, and wherein the fluid in the first flow path flows past the tubes to exchange heat between the fluid in the first flow path and the fluid in the second flow path.

10. The IHX of claim 9, further comprising a channel formed unitarily with the interior surface and located radially outboard of the interior surface, wherein the plurality of tubes includes a first group of tubes and a second group of tubes, wherein the channel is located downstream of the first group of tubes and upstream of the second group of tubes to collect fluid from the first group of tubes before delivering the fluid to the second group of tubes.

11. The IHX of claim 10, wherein the channel is a first channel, the IHX further comprising a second channel formed unitarily with the interior surface and located radially outboard of the interior surface, wherein the second channel is located downstream of the second group of tubes and on an opposite side of the IHX from the first channel relative to the longitudinal axis.

12. The IHX of claim 10, wherein the tubes within the first group of tubes are arranged parallel to one another and oblique to the longitudinal axis, and wherein the tubes within the second group of tubes are arranged parallel to one another and oblique to the longitudinal axis.

13. The IHX of claim 11, wherein the first group of tubes are not parallel to the second group of tubes.

14. The IHX of claim 9, further comprising a plurality of fins, each fin connecting an adjacent pair of the tubes, and wherein a gap exists between the fins and tubes for guiding the fluid passing along the second flow path within the interior surface of the IHX.
